(19) United States
(12) Patent Application Publication
(10) Pub. No.: US 2002/0172244 A1
(43) Pub. Date: Nov. 21, 2002

(54) Self-separating laser diode assembly and method

(76) Inventors: Peng-Chih Li, Southborough, MA (US); Todd Terry, San Jose, CA (US); Robert Lang, Pleasanton, CA (US)

Correspondence Address: SCOTT W HEWETT, 400 WEST THIRD STREET, #223, SANTA ROSA, CA, 95401

(21) Appl. No.: 09/861,232

(22) Filed: May 17, 2001

(51) Int. Cl. H01S 3/04

(52) U.S. Cl. 372/36

(57) ABSTRACT

A laser diode bar is separated into laser diode dice after bonding the laser diode bar to a submount. In one embodiment a GaAs laser diode bar is soldered to a diamond submount with gold—tin solder. The difference in the coefficient of thermal expansion between the submount material and the laser bar material is sufficient to create tensile stress in the laser diode bar and cleave the laser diode bar into dice as the assembly cools from the soldering temperature. Use of an electrically insulating submount material allows the laser diodes to be connected in series. Diamond blanks that are essentially un-metallized submounts are used during assembly to avoid bowing, or “smile”, of the laser diode assembly.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to laser diodes mounted on a common mounting block and more particularly to a plurality of laser diodes separated from each other after bonding a laser bar with the laser diodes to the mounting block.

### BACKGROUND OF THE INVENTION

Laser diode assemblies can be used in a variety of applications. In some applications, a number of diodes operating at the same wavelength are assembled to create a high-power light source by combining the output of all the laser diodes together. In another application, a number of diodes might be assembled to couple into a corresponding number of optical inputs, such as optical fibers. In many applications the heat generated by the laser diode during operation might reduce the output level, efficiency, and possibly the operating lifetime of the laser diode. Therefore it is desirable to conduct this heat away from the laser diode, which is often accomplished by bonding the laser diode to a heat sink or “submount”. The heat sink may be actively cooled with a heat-exchange system, such as with a thermoelectric (“TE“) cooler or by circulating a fluid in contact with the heat sink, or the heat sink may be passively cooled by the ambient environment.

Conducting heat away from the laser diodes can be especially important in multi-diode assemblies because each laser diode generates heat during operation and they are typically in close proximity to each other. However, thermal mismatch between the heat sink material and laser diodes over the operating temperature range of the assembly can cause problems, such as cracking of the laser diode material, which is typically a semiconductor material such as GaAs. GaAs is relatively weak and brittle compared to many common heat sink materials, such as diamond and copper.

In some laser diode assemblies individual laser diode chips or “dice” are bonded to the submount to avoid bonding a relatively large multi-laser diode strip to the submount. While this reduces the problems arising from thermal mismatch, aligning the dice can be difficult. The output aperture of the laser diodes might only be 100 microns or less, and aligning several laser diodes to a common lens or other structure might require skillful assembly, expensive tooling, and long assembly time.

Another approach is to bond a laser diode strip or “bar” to a submount that has a similar linear coefficient of thermal expansion (“CTE”) as the laser diode bar material. This may require a compromise in the thermal conductivity of the submount material. In yet another approach, a laser diode bar is sandwiched between, but not bonded to, mounting material. This allows for some movement of the mounting material with respect to the laser diode bar as the temperature of the assembly changes, but may result in reduced heat sinking of the laser diodes because the laser diodes do not obtain the intimate contact with the heat sink that can be achieved with solder bonding, for example.

In some applications, it is desirable to assemble a number of laser diodes that are electrically connected in series. Laser diodes often have one electrical contact on one face (e.g. the “bottom”) of the die and another electrical contact on another face (e.g. the “top”) of the die. If a number of laser diode dice are solder-attached to a submount, providing electrical isolation between the dice on the submount can allow the laser diodes to be series connected, but conventional techniques still typically require assembling and aligning each die. This can take a lot of assembly time and require sufficient room between the dice to allow for the alignment of the dice. Another problem that can arise is that either the thermal profile of the assembly must be carefully controlled as dice are added to prevent the dice that have already been soldered down from becoming un-soldered, or solders with successively lower melting points are used. Either approach becomes more difficult and time consuming as additional laser diode dice are added to the assembly.

Therefore, it is desirable to fabricate a laser diode assembly having a number of laser diodes with apertures at a consistent height. It is also desirable to fabricate a multi-laser diode assembly wherein the laser diodes are connected in series. It is further desirable that a laser diode assembly having a number of laser diodes make efficient use of the submount area and be easy to manufacture.

### BRIEF SUMMARY OF THE INVENTION

A laser diode assembly is fabricated by bonding a laser diode bar having at least two laser diodes to a submount. The laser diodes are then separated so that each is bonded to the submount in a single bonding step. In a particular embodiment the submount is an electrically insulating material, such as BeO or diamond, and the laser diodes are electrically separated on the submount, allowing the diodes to be connected in series. Bonding the laser diode bar before separating the laser diodes achieves a laser diode-submount assembly with little variation between the heights of the laser diode apertures.

In a particular embodiment, gold—tin solder is used to bond a GaAs laser diode bar to a diamond submount. Cleave regions of the laser diode bar were defined prior to bonding, for example by notching the back facet of the laser diode bar, scribing a cleave alley on the top of the laser diode bar, leaving an unplated cleave alley on the top and/or bottom of the laser diode bar, and by leaving an unsoldered region between laser diodes. After soldering, the laser diode bar spontaneously cleaved into a number of laser diode chips because of the tensile thermal stress arising in the laser diode bar from the differential coefficients of thermal expansion of the GaAs and diamond. In one instance, seven laser diodes were cleaved from the laser diode bar, in another instance, nine.

An advantage of this approach is that a laser diode bar with a somewhat arbitrary number of laser diodes can be bonded to the submount and then cleaved, into 2, 4, 7, 9or more dice, for example. Thus, alignment and bonding time does not scale with the number of laser chips being attached to the submount, as it does if dice are individually aligned and attached to the submount. Similarly, manipulation of the relatively large laser diode bar is typically easier than trying to manipulate a single laser diode die, and is easier to align.

In another embodiment, the laser bar was bonded to a metal submount, which was then stretched to separate the laser diode bar into laser diode chips. In yet another embodiment the laser diode bar was bonded to the submount and then separated into laser diode chips by sawing or laser cutting.

A laser diode assembly having seven GaAs laser diode chips less than about 2 mils apart was fabricated on a diamond submount. Each of the laser diodes was focused onto a common optic fiber lens. The even height of the apertures of the laser diodes and negligible bowing, or “smile”, provided efficient coupling to the optic fiber. The closely spaced laser diode chips made efficient use of the diamond submount area and resulted in a compact and robust multi-laser assembly.

### BRIEF DESCRIPTION OF THE DRAWINGS

FIG. 1 is a simplified end view of laser diode dice bonded to a submount according to an embodiment of the present invention.

FIG. 2A is a simplified top view of a submount for use in a multi-laser assembly according to an embodiment of the present invention.

FIG. 2B is a simplified top view of the submount shown in FIG. 2A with a laser diode bar.

FIG. 2C is a simplified top view of the submount and laser diode dice separated from the laser bar after bonding the laser bar to the submount.

FIG. 2D is a simplified top view of the laser diode dice connected in series with wire bonds.

FIG. 3 is a simplified cross section of a portion of a multi-laser assembly according to an embodiment of the present invention.

FIG. 4A is a simplified perspective view of an assembly tool for bonding laser bars to submounts according to an embodiment of the present invention.

FIG. 4B is a simplified cross section of a detailed portion of the assembly tool illustrated in FIG. 4A.

FIG. 4C is a simplified perspective view of a diamond submount.

FIG. 5A is a simplified top view of a laser diode bar and metal submount assembly.

FIG. 5B is a simplified top view of the assembly shown in FIG. 5A after the laser diode bar has been separated into dice.

FIG. 6 is a simplified perspective view of a multi-laser diode source according to an embodiment of the present invention.

FIG. 7A is a simplified flow chart of a process for manufacturing multi-laser assemblies according to an embodiment of the present invention.

7B is a simplified flow chart of a process of thermally separating dice from a laser diode bar mounted to a submount according to an embodiment of the present invention.

### DETAILED DESCRIPTION OF THE INVENTION

The present invention provides an assembly of multiple laser diodes bonded to a submount in a single bonding operation and subsequently separated into laser diode dice. Bonding a laser bar to the submount before separation of the dice facilitates alignment of the dice, particularly of the height of the laser aperture, because bonding the laser bar in a single operation avoids individual manipulation of the several dice. The resulting multi-laser diode assembly is easily focused onto a fiber lens, for example.

### I. Exemplary Laser Diode Assemblies

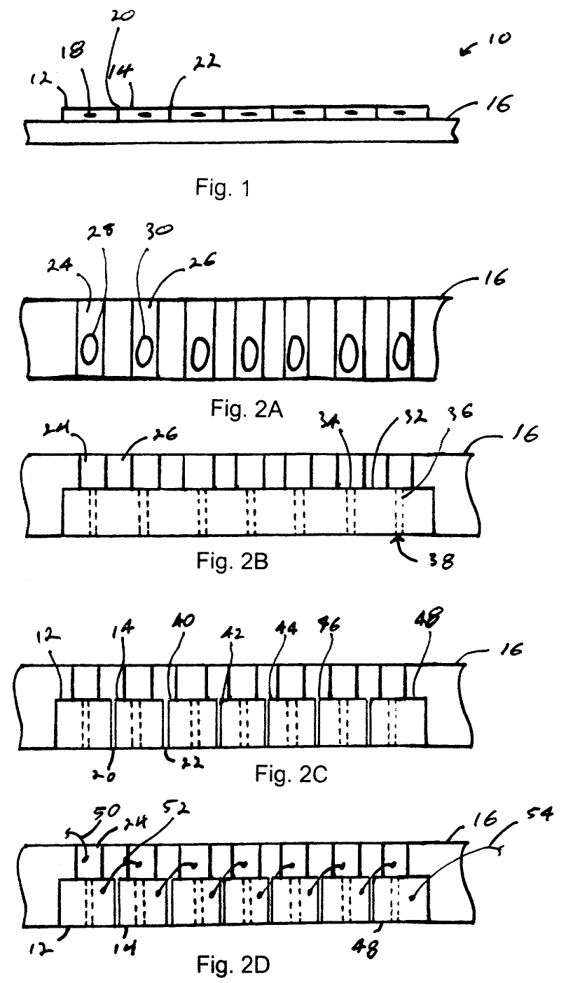

FIG. 1 is a simplified end view of a laser assembly 10 having a number of laser diode dice 12, 14 bonded to a submount 16 according to an embodiment of the present invention. The figures are not to scale, with some features being exaggerated for purposes of illustration. The term “submount” is used for purposes of discussion to refer to the structure to which the laser diode dice, sometimes referred to as “chips”, are bonded. Other terms might be used to describe the submount, such as “heatsink” or “carrier”. The laser diode dice are separated from a laser bar, which typically has several laser diode devices formed in a strip of solid-state laser material. Many solid-state laser materials are known, including compound semiconductors such as gallium-arsenide (“GaAs”). For purposes of discussion, reference to a semiconductor material such as GaAs includes doped materials. The laser light from the laser diode dice is emitted from an emitter 18, which is typically the end of a waveguide formed in the laser material. The individual dice are separated by gaps 20, 22, which may be very narrow and even as small as about 1.5 microns.

FIG. 2A is a top view of a portion of the submount 16 illustrating metallization regions 24, 26. The submount material is an electrically insulating material such as diamond, beryllium oxide (“BeO”), aluminum nitride (“ALN”), alumina (“A₂O₃”), or silicon carbide (“SiC”). In other embodiments the submount is made of metal or layers of metal, such as copper—molybdenum—copper, which can be made to match or nearly match the coefficient of thermal expansion (“CTE”) of the laser bar material. Electrically insulating materials that are relatively good thermal conductors, such as diamond and BeO, are particularly desirable in some embodiments to provide electrical insulation between devices while conducting heat away from the active region of the device to a heat sink or heat exchanger.

Metallization regions 24, 26 are formed on the electrically insulating submount material. These regions can be formed using a variety of techniques including metal plating, thin-film, and thick film techniques, many of which are known in the art. In a particular embodiment the metallization regions were plated gold. These metallization regions provide an interface between the submount material and the laser bar to allow bonding of the laser bar to the submount in selected locations and to allow wire bonding to the metallized regions of the submount. In other embodiments the laser bar might be bonded underneath its entire area. If the thermal conductivity of the metallization material is greater than the underlying submount material, the metallization regions can also serve as heat spreaders.

For example, a laser diode that is bonded to the metallization region with solder transfers heat generated by the device fairly efficiently to the metallization region through the solder. If the area of the metallization region is greater than the area of the solder contact and the thermal resistance of the metallization region (per unit area) is less than the submount, then the heat coupled to the metallization region can be spread over the metallization area. Some materials, such as diamond, have a greater thermal conductivity than the metal of the metallization region, and this region is provided for electrical and mechanical contact to the laser diode device.

Regions of solder 28, 30 are shown on the submount 16 within the metallization regions 24, 26. The solder can be applied as a screened solder paste. In other embodiments the solder can be applied to a surface of the laser bar, or solder preforms can be assembled between the submount and the laser bar before heating the solder to bond the laser bar to the submount, or solder can be sputtered or otherwise applied to one or both of the mating surfaces of the laser bar and submount. The solder regions are shown as ovals, but could be any of a number of shapes. It is generally desirable that the amount of solder be sufficient to wet the intended contact regions between the laser bar and the submount without undue excess solder being present after flowing and solidification. Alternatively, the laser bar can be bonded to the submount using other techniques, such as eutectic bonding.

The laser bar can be bonded to the submount by providing the constituents of a eutectic composition at the interface and heating the assembly until the eutectic forms and flows between the laser bar and the submount. A variety of techniques can be used for eutectic bonding, such as co-sputtering the constituents of the eutectic onto one or both of the mating surfaces of the laser bar and submount, or providing one constituent on one mating surface and another on the opposite mating surface. Whether using solder, eutectic, or other bonding techniques, it is generally desirable that the laser diodes are securely bonded to the submount over the operating temperature range of the assembly and that the bond provides good thermal coupling between the laser device and the submount and an electrical connection between the metallization region and bonded laser diode die.

FIG. 2B is a top view of the submount 16 shown in FIG. 2A with a laser bar 32 bonded to the submount. The laser bar has a number of active laser regions 34, 36 that will provide laser outputs at the emitting facet (surface) 38 of the laser bar when active. The active laser regions are shown as dotted lines for purposes of illustration only. Typically, the active regions are within the body of the die and the top surface of the die is metallized or partly metallized for subsequent electrical wiring. The active laser regions are shown as being generally centered over the metallization regions, which provides good thermal conduction from the active laser regions, but this configuration is not required.

FIG. 2C is a top view of the submount 16 shown in FIG. 2B after the laser bar has been separated into laser diode dice 12, 14, 40, 42, 44, 46, 48. The laser diode dice are separated by gaps 20, 22. The gaps provide electrical isolation between laser diode devices on the electrically insulating submount 16.

FIG. 2D is a top view of the submount 16 and the laser diode dice connected in series with wire bonds 50, 52. A first wire bond 50 connects to the “bottom” of the first die 12 through the first metallization region 24 and the solder (not shown in this view) between the first die and the first metallization region. A second wire bond 52 connects the “top” of the first die to the bottom of the second die 14 through the second metallization region, and so forth. Finally, the top of the last die 48 is connected to the other terminal of the electrical supply, typically ground with a wire bond. The terms “first”, “second”, “last”, “top”, and “bottom” are used purely for convenient description and should not be construed as limiting.

### II. Thermal Cleaving

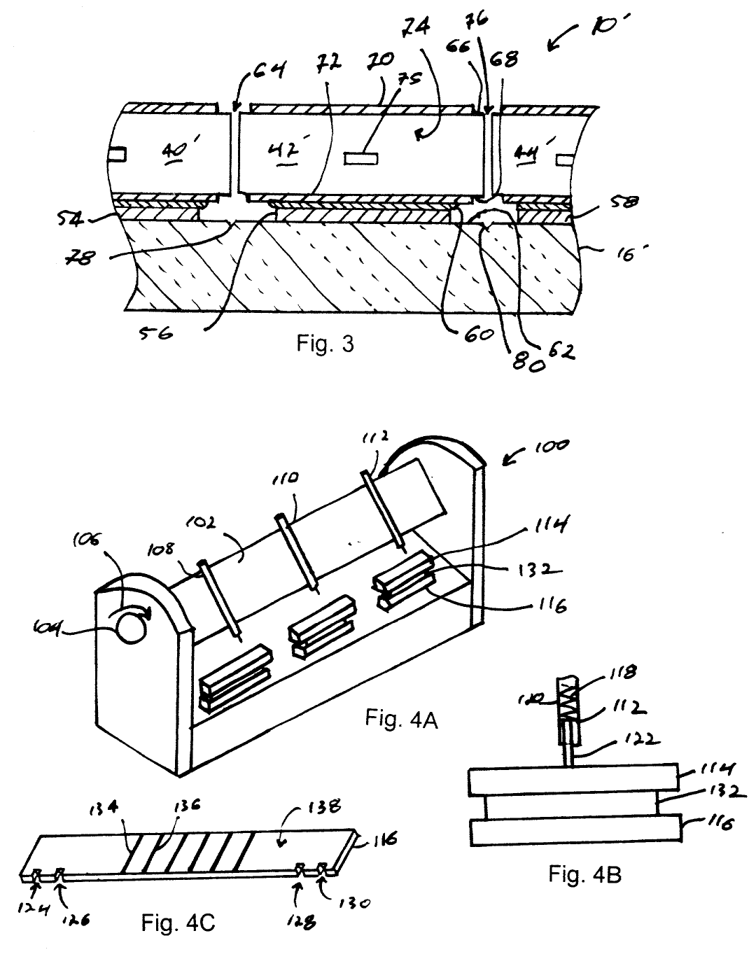

FIG. 3 is a simplified cross section of a portion of multi-laser diode assembly 10′ according to an embodiment of the present invention. The submount 16′ is diamond, but could be BeO or other electrically insulating material, with a relatively low CTE. The laser diodes 40′, 42′, 44′ are made from GaAs or other laser material with a relatively high CTE. For example, the diamond used in the submount has a CTE of about 2×10⁶/° C. while GaAs has a CTE of about 6.5×10⁶/° C. Metallization regions 54, 56, 58 have been defined on the submount. A solder layer 60 bonds the laser diode die 42′ to the corresponding metallization region 56. The metallization region does not extend to the edges of the laser diode die, leaving an unsoldered “window” region 62. The width of this region is about 250 microns on each side (i.e. 500 microns between metallization regions) in a particular embodiment, which allows tensile stress to build in the unsoldered portion of the laser diode bar as the assembly cools, eventually cleaving the laser diode bar within the window. The laser diode dice 40′, 42′ are separated by a gap 64 that was formed when the assembly cooled after soldering a laser bar to the submount. In a particular embodiment, this gap is about 1.5 microns wide, but could be wider in other embodiments. The gap cleanly separates the adjacent laser diode chips and allows many chips to be closely spaced on the submount without touching.

Similarly, windows 66, 68 have been defined in the relatively thick gold plating 70, 72 of the laser diode dice 42′. The light is emitted from an aperture 75, which is essentially the end of a waveguide formed in the laser die. These windows were masked so that gold would not plate out on them and run essentially perpendicular to the emitting facet 74 of the laser diode 42′. The absence of plated gold in these windows provides a weakened region for the initiation and propagation of cleaving, acting similar to a notch in the laser bar.

A laser bar (ref. num. 16, FIG. 2B) that included a number of the laser diode dice 40′, 42′, 44′ was soldered to the diamond submount 16′ by heating the assembly to above the melting point of the solder. In a particular embodiment gold—tin solder was used because it is a hard solder with good wetting properties and a relatively high melting point of 280° C. Previously, such hard solder was not used with diamond submounts because the differential CTEs of the diamond submount and laser bar would cause the laser bar to crack upon cooling. However, the applicants discovered that this mechanism, which previously caused failures in the finished assembly, could be used to achieve a beneficial result.

In particular, it was discovered that the differential CTEs could be used to cleave the laser bar in a controlled manner and to separate laser diode dice from the bar, while also soldering all of the laser diode dice down onto the submount in a single step. In general terms, after the solder changes from liquid to solid, further cooling of the assembly builds sufficient tensile stress in the laser diode bar to cleave the bar into laser diode dice. Using a diamond submount, GaAs laser bar, and gold—tin solder, cooling from the melting point of the solder to room temperature was sufficient to cleave the laser bar when windows between the plated metallization regions of the laser bar and the between the metallized regions of the submount were provided to generate the desired thermal stress between laser diodes.

The gaps formed by such thermal cleaving are typically about 1.5 microns wide at room temperature. The gaps remain open, and thus electrically isolating, even at the upper end of the operating temperature range of the laser diode assembly. The location of the cleave gaps 67, 76 can be controlled by notching, scribing, masking of plated metal, removal of plated metal or other material or otherwise defining a mechanically weakened location on the laser bar to facilitate cleave initiation, such as by masking or removal of the plated metal. Grooves 78, 80 were also scribed in the submount 16′ to control where the laser bar would cleave. Assemblies using other materials can be used with appropriate adaptation. In a particular embodiment, the laser bar was notched at the back facet between laser diodes.

For example, materials with less difference between the CTE of the submount and the CTE of the laser bar might be cooled below room temperature to achieve cleaving. Similarly, a solder with a lower melting point could be used to solder a diamond submount to a GaAs laser bar and the assembly cooled below room temperature to achieve the desired tensile stress for cleaving. Another system might be used with a stronger laser bar material that requires greater tensile stress to cleave. A high-melting point solder or eutectic could be used in combination with cooling to a low temperature to achieve cleaving. In general, the gap between adjoining laser diode dice should remain open over the operating temperature range of the finished assembly.

FIG. 4A is a simplified perspective view of a tooling fixture 100 for assembling laser diode assemblies according to the present invention. A plate 102 rotates about an axel 104 in the direction of the arrow 106. Spring-loaded clamps 108, 110, 112 commonly called “pogo pins” are attached to the plate 102. When the plate is rotated, the pogo pins contact blanks 114, which presses the laser bar 132 against the submount 116.

The blanks are relatively stiff compared to the laser bars. The blanks press the laser bars against the submounts while the assemblies are heated to melt the solder or form eutectic. The blanks are made of the same material as the submounts and are generally the same size, but this is not required. Using a blank in combination with a spring-loaded pogo pin provides a relatively uniform pressure on the laser bar and provides a symmetrical mechanical and thermal arrangement that avoids bowing of the submount and laser bar, commonly referred to as “smile”. Smile offsets the height of the apertures of the laser diodes with respect to each other. This can adversely affect focusing or alignment of the laser diode dice after separation, and hence the power coupled from the laser diodes into a fiber lens or other optical element.

In one embodiment the laser bar 132 had seven laser diode devices that were bonded to the submount 116 and thermally cleaved into seven electrically isolated dice. The seven-diode assembly was then tested for smile by measuring the near field emission of the assembly with a camera and measuring the center-to-center offset of the light from each aperture. The variation in height of all the apertures was less than ±1 micron and in one instance there was no measurable smile.

FIG. 4B is a simplified cross section of a pogo pin 112 pressing a blank 114 against a laser diode bar 132 to solder the laser diode bar to the submount 116. The pogo pin has a spring 118 inside a tubular sleeve 120. The spring pushes against a pin 122, which in turn pushes against the blank 114. The submount 116 typically sits on a surface of the tooling fixture (ref. no. 100, FIG. 4A). The entire tooling fixture with the laser diode bar-submount-blank assemblies can be heated to melt the bonding precursor material, i.e. eutectic or solder, and then cooled. The pogo pins provide a slight compressive force to push the laser diode bar toward the submount when the bonding precursor material melts. The pin 122 is essentially perpendicular to the blank and contacts the center or near center of the blank. The stiff blank provides substantially even pressure to the laser diode bar.

FIG. 4C is a simplified perspective view of a diamond submount 116 prepared for assembly with a laser diode bar according to an embodiment of the present invention. The diamond submount includes alignment notches 124, 126, 128, 130 that are used for aligning the submount in the assembly tooling. A laser was used to form grooves 134, 136 on the top 138 of the submount. These grooves avoid metal from bridging between devices, even though the metallization regions (not shown in this view, see ref. no. 24, FIG. 2A) on the diamond submount are set back from the grooves by about 250 microns. It is believed the grooves in the submount help confine the stresses in the cleave region of the laser diode bar that is subsequently bonded to the submount. The diamond submount is about 550 by 80 mils and about 12 mils thick, with the grooves being about 2 mils deep. The alignment notches 124, 126, 128, 130 are about 12×12 mils, and the flatness of the submount is held to within 1 mil.

During the development of this method, the inventors achieved the separation of seven lasers from a seven-laser bar in the first attempt. In the second and third attempts, eight of nine and nine of nine were successfully separated.

### Mechanical Cleaving

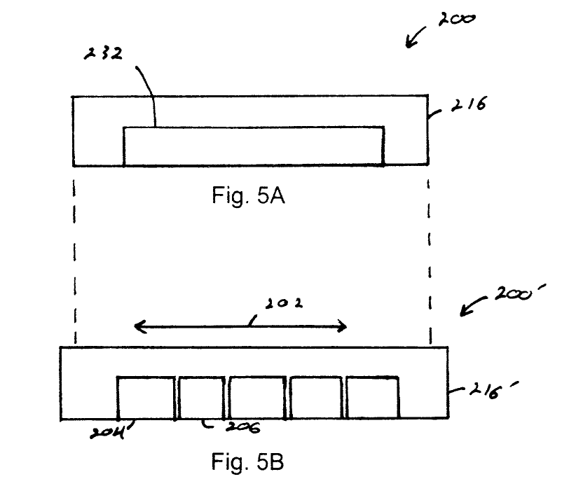

FIG. 5A is a simplified top view of a laser diode assembly 200 according to an embodiment of the present invention using mechanical stress to cleave a laser diode bar 232 into a number of laser diode dice. The submount 216 is made of metal, such as copper or a layer of molybdenum sandwiched between layers of copper. Metal submounts provide relatively good thermal conductivity and allow the submount to be stretched to cleave the mounted laser diode bar 232. Layered submounts can be manufactured to have essentially the same CTE as the laser diode bar material by selecting the thickness of the layers of the selected materials. A symmetrical sandwich configuration, such as copper—molybdenum—copper, avoids bowing of the layered metals in response to changes in temperature. In other cases the metallic submount might have a higher or lower CTE than the material of the laser diode bar.

FIG. 5B is a simplified top view of the laser diode assembly 200′ after the submount 216′ has been stretched in the direction of the arrow 202 to cleave the laser diode bar into laser diode dice 204, 206. As with thermal cleaving, the location where cleaving is initiated can be controlled by providing a mechanically weakened feature, such as a scribe mark or notch. Scribing can be done with a mechanical scribe, such as a diamond or carbide-tipped scribe, or by laser scribing. Alternatively, a saw can be used to notch the edge of the laser bar where cleaving is to be initiated or to saw a groove along the direction of the desired cleave.

In another embodiment, a saw was used to separate the laser diode bar into dice after the laser diode bar had been bonded to the submount. The saw cut through the laser diode bar and partially into the submount. While this technique achieves the advantages of mounting a number of laser diodes to a submount in a single bonding step with low smile, separation of the devices by sawing was found to have a higher incidence of inter-device shorting than separation by thermal cleaving.

### IV. An Exemplary Laser Diode Assembly

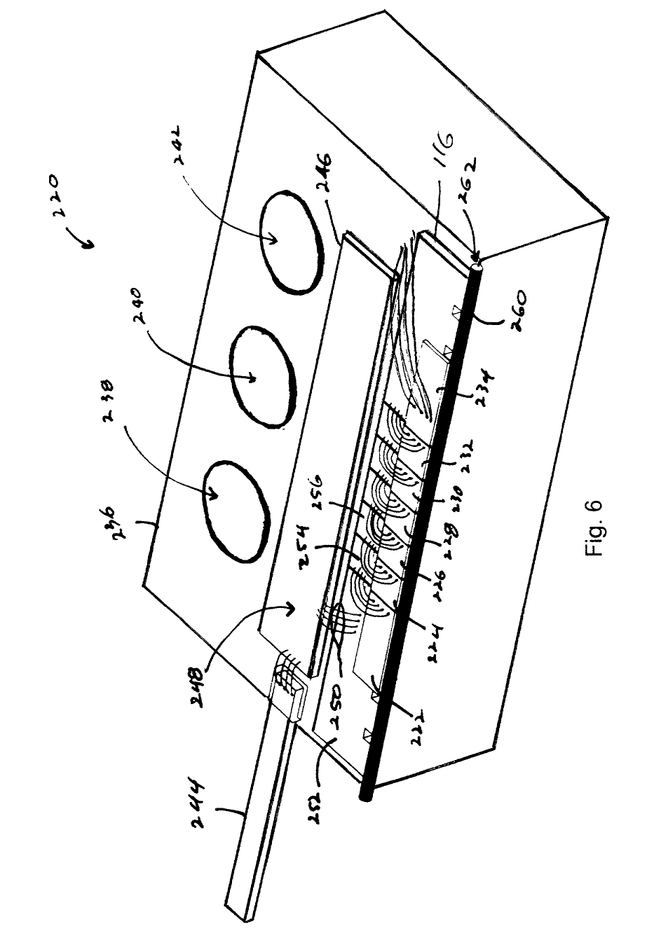

FIG. 6 is a simplified perspective view of a laser diode assembly 220 according to an embodiment of the present invention. Seven laser diode dice 222, 224, 226, 228, 230, 232, 234 have been bonded to a diamond submount 116. The diamond submount is attached to a copper heatsink 236, which has three holes 238, 240, 242 that can be used to attach the assembly to another structure. A tab 244 provides convenient electrical connection for testing, and is typically broken off when the laser diode assembly is incorporated into a laser product.

An electrical contact 246 is a thin piece of aluminum nitride that is metallized on the top 248 and bottom. The dielectric center of the electrical contact isolates the top of the electrical contact from the heatsink 236. The bottom of the electrical contact is soldered to the heatsink 236, while the top 248 provides a convenient surface for wire bonding.

Wire bonds 250 connect the electrical contact 246 to a first metallized portion of the diamond submount 116. The metallized regions of the diamond submount are not separately shown in this view. One side (i.e. the bottom) of a first laser diode 222 is electrically connected to a first metallization portion 252 of the diamond submount. The other side (i.e. the top) of the first laser diode 222 is wire bonded to a second portion 254 of the diamond submount. The first portion of the diamond submount is electrically isolated from the second portion of the diamond submount. The bottom of a second laser diode 224 is electrically connected to the second portion of the diamond submount and the top of the second laser diode is electrically connected to a third portion 256 of the diamond submount. This arrangement continues until the top of the last (seventh) laser diode 234 is connected to the copper heatsink 236 (ground potential). Thus the laser diodes are connected in series. Multiple wire bonds provide a low-resistance connection and increased reliability in the event that one of the wire bonds fails. Alternatively, wire mesh or ribbon could be used. It is generally desirable to avoid bonding over the active region of the laser diode, which is typically a stripe about 100 microns wide.

A laser bar with the laser diodes was bonded to the submount in a single bonding operation, and then the laser bar was separated into the laser diode chips. The laser diodes are arranged so that the laser output from each is coupled into an optical fiber lens 260. The circular end 262 of the lens is shown for purposes of illustration, but the optical fiber lens typically couples the light from the laser diodes into an optical fiber transmission line that extends from one or both ends of the assembly 220.

### V. Exemplary Processes

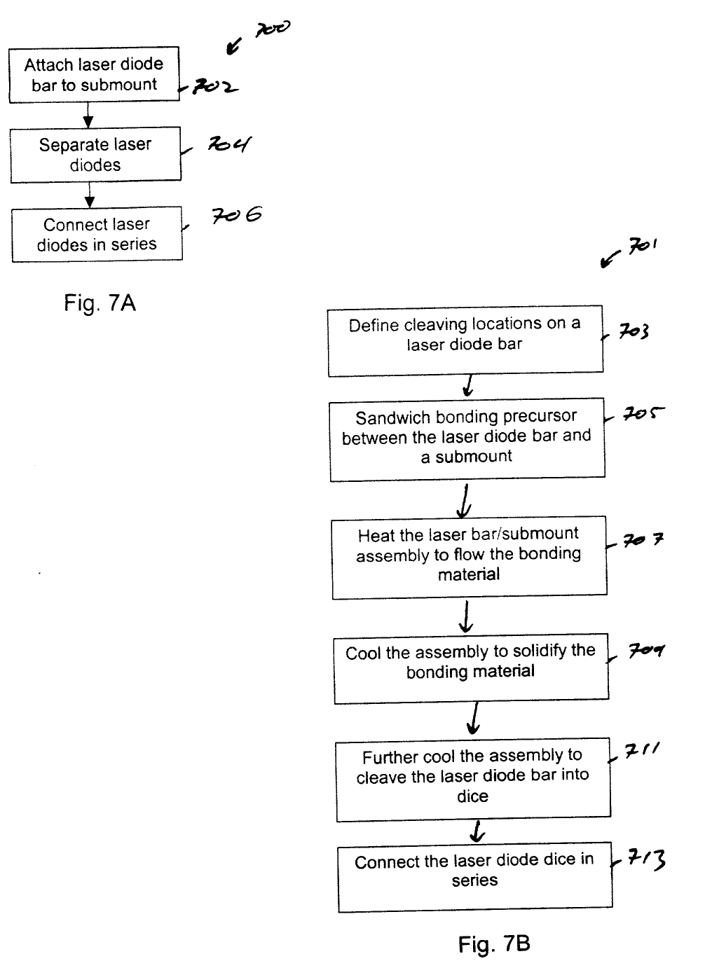

FIG. 7A is a simplified flow chart of a process 700 according to an embodiment of the present invention. A laser diode bar is bonded to a submount (step 702) by soldering or other means. After bonding the laser diode bar to the submount, the laser diode bar is separated into laser diode chips (step 704), by sawing, mechanical cleaving, thermal cleaving, or other method. In a further embodiment, the submount has electrically isolated regions that allow the laser diodes to be connected in series (step 706). In an alternative embodiment, the submount is electrically conductive and the laser diodes are connected in parallel. Separating the laser diodes after bonding to the submount allows the use of hard solder or other high temperature bonding techniques while accommodating the differential CTEs by controllably cleaving the laser bar to release the tensile strain in the laser bar as it cools from the bonding temperature.

FIG. 7B is a simplified flow chart of another process 701 according to an embodiment of the present invention. Cleaving locations are defined on a laser diode bar (step 703) by mechanically scribing, laser scribing, sawing, providing a metallization window or notching. A bonding precursor, such as a solder preform, solder paste, sputtered solder, or the constituents of a eutectic composition is sandwiched between the laser diode bar and the submount (step 705). The laser diode bar-submount assembly is heated to flow the bonding material (step 707) and then cooled to solidify the bonding material (step 709). The assembly is cooled until the laser diode bar cleaves into a number of laser diode chips (step 711). In a further embodiment, the laser diode chips are connected in series (step 713).

While the invention has been described in conjunction with several specific embodiments, it is evident to those skilled in the art that many further alternatives, modifications, and variations will be apparent in light of the foregoing description. For example, while providing weakened areas to facilitate cleaving has been described by masking plated metal from cleave alleys, scribing, and notching the laser bar, similar features might be formed by etching or ion milling. Similarly, separation of the dice might be obtained by laser cutting, in addition to the specific embodiments described above. While embodiments have been illustrated with one laser device per chip, other embodiments might have a number of laser devices per chip. Thus, the invention described herein is intended to embrace all such alternatives, modifications, applications, and variations as may fall within the spirit and scope of the following claims.

What is claimed is:

1. A method of fabricating a laser diode assembly, the method comprising:
bonding a laser diode bar having at least a first laser diode and a second laser diode to a submount; and then
separating a first laser diode chip and a second laser diode chip from the laser diode bar, the first laser diode chip and the second laser diode chip being bonded to the submount.

2. The method of claim 1 further comprising a step, after the bonding step, of electrically connecting the first laser diode chip to the second laser diode chip in series.

3. The method of claim 1 further comprising a step, before the bonding step, of defining a cleave location between the first laser diode and the second laser diode and wherein the separating step comprises cleaving the laser diode bar into the first laser diode chip and the second laser diode chip.

4. The method of claim 3 wherein the defining a cleave location step comprises notching the laser diode bar.

5. The method of claim 3 wherein the cleaving step comprises mechanically deforming the submount.

6. The method of claim 5 wherein the deforming comprises stretching the submount.

7. The method of claim 3 wherein the bonding step occurs at a first temperature and the cleaving step comprises cooling the laser diode bar to a second temperature so as to develop thermal stress in the laser diode bar that cleaves the laser diode bar into the first laser diode chip and the second laser diode chip.

8. The method of claim 1 wherein the separating step comprises removing laser bar material.

9. The method of claim 8 wherein the removing step comprises sawing.

10. The method of claim 1 wherein the bonding step comprises soldering.

11. A method of fabricating a laser diode assembly, the method comprising:
defining a cleave location on a laser diode bar having at least a first laser diode and a second laser diode
soldering the laser diode bar to a submount at a first region of the submount and at a second region of the submount with solder so as to leave a solder-free window between the first laser diode and the second laser diode to form a submount-laser bar assembly
cooling the submount-laser bar assembly below a melting point of the solder; and
cleaving the laser diode bar into a first laser diode chip and a second laser diode chip.

12. The method of claim 11 wherein the cleaving step comprises mechanical deformation of the submount.

13. The method of claim 11 wherein the cleaving step comprises further cooling the submount-laser bar assembly to a cleaving temperature so as to develop thermal stress in the laser diode bar, the thermal stress initiating and propagating a cleave in the laser diode bar between the first laser diode and the second laser diode.

14. The method of claim 11 wherein the solder-free window has a width of at least about 500 microns between the first region and the second region.

15. A laser diode assembly comprising:
a submount of an electrically insulating material having a submount surface with a first metallized region and a second metallized region, the first metallized region being electrically isolated from the second metallized region;
a first laser diode chip soldered to the first metallized region with a solder;
a second diode chip soldered to the second metallized region with the solder, the first laser diode chip being separated from the second diode chip by
a gap, and the first laser diode chip being electrically connected in series to the second laser diode chip.

16. The laser diode assembly of claim 15 wherein the gap is less than about 2 microns.

17. The laser diode assembly of claim 15 wherein the submount has a surface, the first laser diode chip has a first aperture a first height from the surface and the second laser diode chip has a second aperture a second height from the surface, a difference between the first height and the second height being less than about 1 micron.

18. The laser diode assembly of claim 15 wherein the solder has a melting point of about 280° C.

19. The laser diode assembly of claim 15 wherein the solder comprises gold and tin.

20. The laser diode assembly of claim 15 further comprising
a third laser diode chip soldered to a third metallization region with the solder;
a fourth laser diode chip soldered to a fourth metallization region with the solder;
a fifth laser diode chip soldered to a fifth metallization region with the solder;
a sixth laser diode chip soldered to a sixth metallization region with the solder; and
a seventh laser diode chip soldered to a seventh metallization region with the solder , and the third laser diode chip, t he fourth laser diode chip, the fifth laser diode chip, the sixth laser diode chip, and the seventh laser diode chip are electrically connected in series with the first laser diode chip and the second laser diode chip and wherein the first laser diode chip, the second laser diode chip, the third laser diode chip, the fourth laser diode chip, the fifth laser diode chip, the sixth laser diode chip and the seventh laser diode chip are optically coupled to a lens.

21. The laser diode assembly of claim 20 wherein the lens is an optical fiber lens.

22. A laser diode assembly comprising:
a diamond submount with a first metallization region and a second metallization region;
a first laser diode chip soldered to the first metallization region with gold—tin solder having a melting point of about 280° C.; and
a second laser diode chip soldered to the second metallization region with the gold—tin solder, wherein the first laser diode chip is electrically connected to the second laser diode chip in series.
